(19) United States
(12) Patent Application Publication
(10) Pub. No.: US 2009/0077748 A1
(43) Pub. Date: Mar. 26, 2009

(54) Articulating bed and mattress for the same

(76) Inventor: Willie W. Kim, Anaheim, CA (US)

Correspondence Address: WILLIE W. KIM, 2124 W. CHERRYWOOD LANE, ANAHEIM, CA, 92804, US

(21) Appl. No.: 12/069,142

(22) Filed: Feb. 7, 2008

Related U.S. Application Data
(63) Continuation of application No. 11/859,701, filed on Sep. 21, 2007.

(51) Int. Cl. A61G 7/015

(52) U.S. Cl. 5/613

(57) ABSTRACT

The present invention relates to an articulating bed that is slidingly moved to extend by a given width and lifts the slidingly moved area thereof and to a mattress for use in the articulating bed, the articulating bed including: a first frame having an electrically operating motor, a screw shaft, hinge devices, and devices for articulating the bed mounted thereon; a second frame mounted on the top surface of the first frame in such a manner as to be articulated to four sections; and a third frame mounted on the top surface of the second frame in such a manner as to be articulated to four sections together with the second frame, the third frame being slidingly moved selectively to a left or right side by the guide of the second frame to extend the bed by the given width and being lifted by the slidingly moved area thereof.

### CROSS-REFERENCE TO RELATED APPLICATIONS

This application claims the benefit under 35 U.S.C. §119(a) of U.S. application Ser. No. 11/859,701 filed in the United State Patent and Trade Office on Sep. 21, 2007 the entire disclosure of which is incorporated herein by reference.

### BACKGROUND OF THE INVENTION

1. Field of the Invention

The present invention relates to an articulating bed that is slidingly movable to extend by a given width and lifts the slidingly moved area thereof, thereby enabling a patient lying on the bed to be rolled over or moved laterally, and to a mattress for use in the articulating bed.

2. Background of the Related Art

The present application is suggested to solve the problems suffered in U.S. Pat. No. 7,237,286 (hereinafter, referred to as ‘prior art’) issued on Jul. 3, 2007 which is filed on Jan. 20, 2006 and entitled ‘articulating bed’ by the same applicant as the invention and in U.S. application Ser. No. 11/859,701 entitled ‘articulating bed and method of using the same’ and filed on Sep. 21, 2007 by the same applicant as the invention.

### SUMMARY OF THE INVENTION

Accordingly, the present invention has been made in view of the above-mentioned problems occurring in the prior art, and it is an object of the present invention to provide an articulating bed that is slidingly moved to extend by a given width and lifts the slidingly moved area thereof such that it is very useful when fresh air is provided to a patient lying on the bed in the hospital for a long period of time, especially to his or her back region always abutting against a bed mattress, when a bed sheet is changed with new one, or when he or she sits on a wheelchair so as to move to other places or to go to outside.

To accomplish the above object, according to the present invention, there is provided an articulating bed that is slidingly moved to extend by a given width and lifts the slidingly moved area thereof and to a mattress for use in the articulating bed, the articulating bed including: a first frame having an electrically operating motor, a screw shaft, hinge devices, and devices for articulating the bed mounted thereon; a second frame mounted on the top surface of the first frame in such a manner as to be articulated to four sections; and a third frame mounted on the top surface of the second frame in such a manner as to be articulated to four sections together with the second frame, the third frame being slidingly moved selectively to a left or right side by the guide of the second frame to extend the bed by the given width and being lifted by the slidingly moved area thereof.

According to the present invention, the articulating bed that is operated by the manipulation of an electrically operating switch and has the following functions: a third frame is slidingly movable to a left or right side to extend by a given width; the slidingly moved area of the third frame is lifted with respect to hinges to allow a patient to be turned over; the third frame is returned to an original position thereof; and a second frame and the four sections of the third frame, that is, the upper body region section, the hip region section, the thigh region section, and the leg region section are articulated in concert in the original position.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a configuration of an articulating bed according to the present invention;

FIG. 2 is an exploded perspective view of the articulating bed;

FIG. 3 is an enlarged perspective view showing the main parts of a third frame of the articulating bed;

FIG. 4 is a partially enlarged perspective view showing the assembling structure between a second frame and a third frame of the articulating bed;

FIG. 5 is an enlarged perspective view showing a structure of a hip region of the second frame and the third frame of the articulating bed;

FIG. 6 is a partially enlarged perspective view showing a structure where the third frame coupled to the second frame is slidingly guided;

FIG. 7 is a partially enlarged perspective view showing an assembling structure of the first, second and third frames;

FIG. 8 is a bottom view showing a structure of the thigh region of the third frame;

FIG. 9 is a partially enlarged perspective view showing the main parts of the assembled structure of the first, second and third frames;

FIG. 10A is a partially enlarged longitudinal sectional view showing the assembling state between the slides and the frames as the main parts of the articulating bed;

FIG. 10B is an enlarged sectional view showing the structure in a dotted circle in FIG. 10A;

FIG. 11A is a perspective view showing a first operating step where the third frame is slidingly movable to a right side thereof;

FIG. 11B is a perspective view showing a second operating step where the third frame is lifted at the right side thereof;

FIG. 11C is a perspective view showing a state where the third frame is slidingly movable to a left side thereof and then lifted at the left side thereof;

FIG. 12 is a perspective view showing a structure where a screw shaft, right and left moving pieces, and links that are the most important parts of this invention are in a cooperative relation with respect to one another;

FIG. 13A is a side view showing the articulating bed is in an original position thereof;

FIG. 13B is a side view showing the first operating step where the third frame being in the original position is slidingly moved to the left side and then halts there;

FIG. 13C is a side view showing the first operating step where the third frame slidingly moved to the left side is lifted at one side;

FIG. 14 is a perspective view showing the mechanical parts of the articulating bed;

FIG. 15 is a perspective view showing the articulating bed being operated by sections;

FIG. 16A is a perspective view showing a mattress for use in the articulating bed according to the present invention;

FIG. 16B is a perspective view showing a state where the mattress is mounted on the articulating bed and is in an original position thereof;

FIG. 16C is a perspective view showing a state where the mattress is slidingly moved to a right side thereof in the original position so as to extend the bed width;

FIG. 16D is a perspective view showing a state where the mattress being in the original position is lifted at the right side thereof;

FIG. 17A is a perspective view showing a headrest adapted to be coupled to the articulating bed according to the present invention;

FIG. 17B is a side view showing the headrest of FIG. 17A;

FIG. 18 is a perspective view showing a state where the headrest is coupled to the third frame;

FIG. 19A is a perspective view showing a preparing step before a patient lying on the bed is moved to a wheelchair;

FIG. 19B is a perspective view showing a process of allowing the patient to sit on the bed and move to the wheelchair;

FIG. 20 is a flowchart showing the steps of FIGS.19A and 19B;

FIG. 21A is a perspective view showing a process for changing the sheet of the mattress on which the patient lies with new one;

FIG. 21B is a perspective view showing a state where the patient is turned over completely by the articulating bed of this invention, so as to wash a body rear region (the back, hip, or calf region) of the patient with a towel, to provide refresh air to the patient, or to change the mattress sheet with new one;

FIG. 22 is a flowchart showing the steps of FIGS.21A and 21B;

FIG. 23A is a perspective view showing another embodiment of the mattress for use in the articulating bed according to the present invention; and

FIG. 23B is a perspective view showing the use state of the mattress of FIG. 23A.

### DETAILED DESCRIPTION OF THE PREFERRED EMBODIMENT

The present invention relates to an articulating bed that is slidingly movable to extend by a given width and lifts the slidingly moved area thereof, such that a patient who does not move his body at all by himself is turned to a side, thereby allowing the patient's body to be freely turned on the bed, without having other people's help, and such that the bed is extended larger if necessary, thereby allowing his movements on the bed to be freely performed.

The articulating bed of the present invention includes: a first frame having an electrically operating motor, a screw shaft, and a plurality of devices for articulating the bed; a second frame having four sections articulated simultaneously; and a third frame adapted to be slidingly movable to a left or light side and to be lifted lengthwise by about 50% to 70% of areas, such that a patient may be turned laterally.

On the other hand, the third frame has a mattress assembly located on the top surface thereof so as to allow the patient to lie thereon, and the mattress assembly includes a main mattress provided on the center thereof and a pair of outside mattresses coupled to the both sides of the main mattress so as to extend the mattress by a given width.

The articulating bed of the present invention is useful for nurses looking after unconscious patients or patients who do not move their body at all by themselves, because they sufficiently nurse their patient just by the manipulation of the operating switch.

Generally, since patients in intensive care can not move their body at all according to their intention, they are in the hospital, a home for the aged or a health resort, and in some cases, patients are nursed at their home through the medical treatment of their doctor and nurse.

Especially, since the patients in intensive case do not move their body at all, they absolutely need their nurses when they do something, for example, they receive their medical treatment, they go to stool, they wash their body, or the like. However, if a long period of nursing is needed, the nurses inclusive of the members of the family of the patient have had tough time. More particularly, they are utterly exhausted when they turn the patient to a side so as to conduct bed sore care and when they move the patient to a wheelchair so as to receive other medical treatment or to go to outside.

Especially, if the patient is heavy, the nurses might be hurt on the waist, shoulders, or arms during their assistance, and in this case, they bring a case on judgment for receiving the compensation money from the patient or hospital. This is serious to all of the patient, the patient family, the hospital, and the government, and so as to overcome the above-mentioned problems, thus, there is provided an articulating bed according to the present invention.

Hereinafter, an explanation on an articulating bed according to the present invention will be given with reference to the attached drawings.

To easily understand the principles of the present invention, first, the main parts of an articulating bed according to the present invention should be in detail suggested. The articulating bed basically includes a first frame 100, a second frame 200, a third frame 300, a mattress assembly 400, and a headrest 500.

The first frame 100 is a base frame for mounting the second frame 200 and the third frame 300 sequentially thereon, and the second frame 200 is mounted on the top surface of the first frame 100 and is hingably operated to four sections. The third frame 300 is mounted on the top surface of the second frame 200 and includes four sections hingably operated by means of the second frame 200. When horizontally positioned, the third frame 300 is slidingly movable to a left or right side according to a user's selection, but when the sliding movement stops, the slidingly moved area of the third frame 300 is lifted, such that a patient lying on the bed can be turned to a side.

On the other hand, the second frame 200 is not necessarily needed in the parts of the articulating bed according to the present invention, because the third frame 300 can be mounted directly on the first frame 100. Even though the third frame 300 is not mounted on the second frame 200, it can perform all of the functions of being hingably operated to the four sections, slidingly moving in a left or right direction, and lifting the moved area. In the preferred embodiment of the present invention, however, no explanation on the means for mounting the third frame 30 directly onto the first frame 100 will be given.

The above-described drawing figures illustrate the described apparatus in at least one of its preferred, best mode embodiment, which is further defined in detail in the following description.

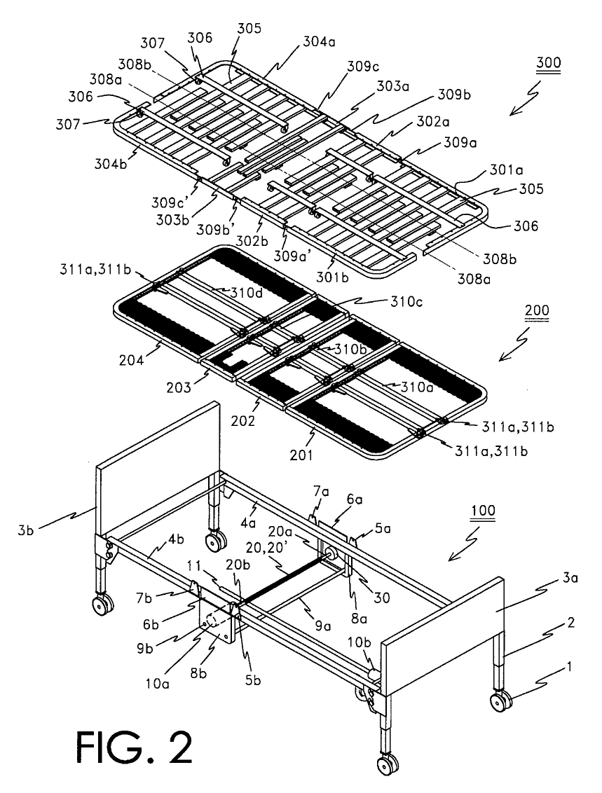

First, the first frame 100 will be described. As shown in FIG. 2, the first frame 100 has a base frame having four legs 2 and main bars 4a and 4b coupled horizontally to the four legs 2, each leg 2 having a wheel 1 mounted at the end thereof. On the other hand, a foot plate 3a and a head plate 3b are illustrated in FIG. 2, but they are not necessarily needed in the preferred embodiment of the present invention.

The main bars 4a and 4b have stationary plates 6a and 6b extended from the upper surfaces of the respective central portions thereof so as to prevent a hip region frame portion 203 of the second frame 200 from being moved. The stationary plates 6a and 6b have pairs of hinge-fixing plates 5a, 5b, 7a and 7b formed on the respectively both sides thereof, and the main bars 4a and 4b have driving device plates 8a and 8b extended from the both side surfaces of the respective central portions thereof, the driving device plates 8a and 8b having two fixing bars 9a and 9b mounted transversely on the both bottom sides of the undersides thereof. Further, the driving device plates 8a and 8b have a screw shaft 20 mounted transversely at the inner surfaces thereof. The screw shaft 20 has a screw 20′ formed along the entire length thereof and a right moving piece 40a and a left moving piece 40b coupled therealong. Further, the screw shaft 20 having the right moving piece 40a and the left moving piece 40b coupled therealong has idle portions 20a and 20b formed along the both end portions thereof. The idle portion 20a is connected to a motor 10a having a control switch (not shown) adapted to be mounted on the driving device plate 8a and the other side idle portion 20b is connected to a bearing 30 adapted to be mounted on the driving device plate 8b. Moreover, a push shaft 11 and a motor 10b having a control switch (not shown) are mounted perpendicularly to the screw shaft 20. As a result, the above-described parts of the first frame 100 enable the second frame 200 and the third frame 300 to be articulated.

Next, the second frame 200 will be described. As shown in FIG. 2, the second frame 200 have articulated four sections and is formed of a plurality of C-shaped steel beams having a space at the inside thereof in such a manner as to insert thereinto the vertical bearings and horizontal bearings formed on a plurality of slides constituting the third frame 300, as will be described below. The second frame 200 that is formed of the C-shaped steel beams and basically includes a leg region frame portion 201, a thigh region frame portion 202, the hip region frame portion 203, and an upper body region frame portion 204.

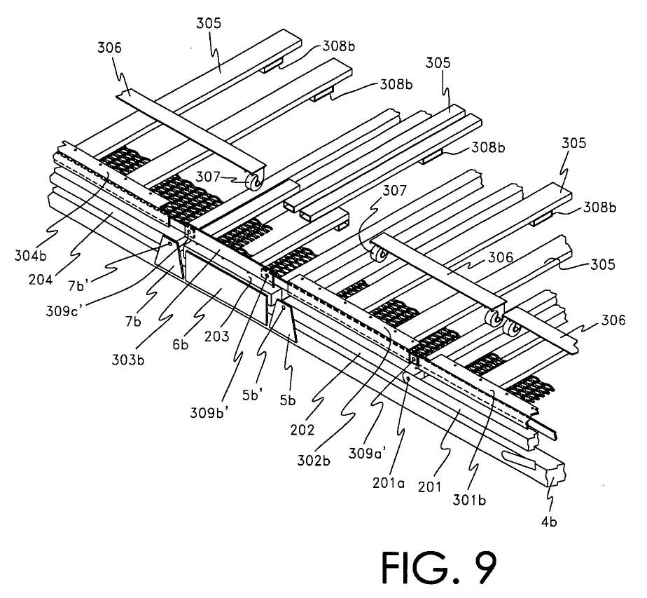

As shown in FIG. 9, the hip region frame portion 203 of the second frame 200 is firmly fixed to the stationary plates 6a and 6b so as not to be moved from its coupled position, and the thigh region frame portion 202 and the upper body region frame portion 204 are coupled to the hinge-fixing plates 5a, 5b, 7a and 7b mounted at the both sides of the fixed hip region frame portion 203 by means of hinge pins 5b′ and 7b′. The leg region frame portion 201 is articulatedly coupled to one side surface of the thigh region frame portion 202 by means of a hinge pin 201a.

The upper body region frame portion 204 and the thigh region frame portion 202 after coupled to each other are connected at the central portions of the undersides thereof to the end portion of the push shaft 11 having a separate articulating link (not shown), and as the rotary motion of the motor 10b is changed into the linear motion by means of the crank operation, the push shaft 11 pushes or pulls to perform a rod motion.

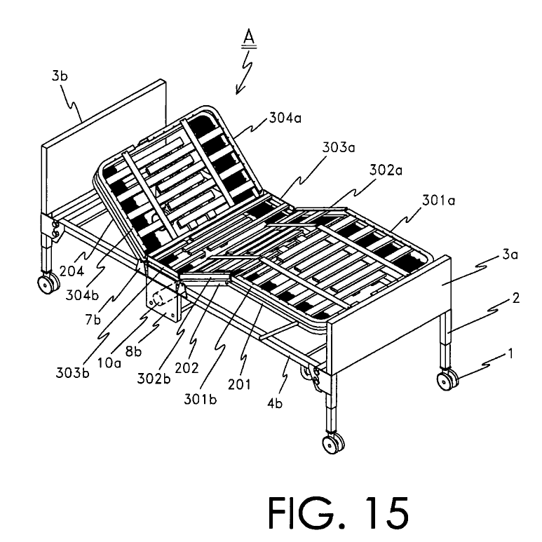

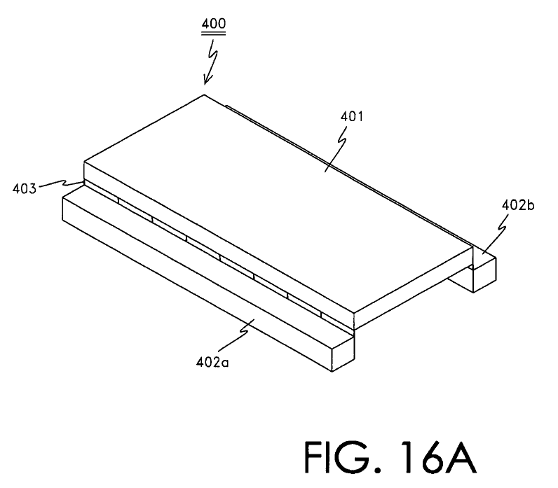

On the other hand, the push shaft 11 having the linear motion is coupled at the intermediate and end portions thereof to the separate articulating links adapted to couple the thigh region frame portion 202 and the upper body region frame portion 204 thereto. Thus, when the push shaft 11 conducts the linear motion, the upper body region frame portion 204 and the thigh region frame portion 202 are lifted to the opposite sides with respect to the shafts of the hinge pins 5b′ and 7b′ as shown in FIG. 9, and simultaneously, as the leg region frame portion 201 is coupled to the thigh region frame portion 202 by means of the hinge pin 205, the coupled portion therebetween is lifted. The second frame 200 that is articulated in the above-mentioned manner enables the third frame 300 mounted on the top surface thereof to be articulatedly operated, as shown in FIG. 15.

Now, the third frame 300 will be explained. The third frame 300 largely includes a plurality of frames as a mattress base plate corresponding to a patient's body regions that are articulatedly operated and a plurality of slides adapted to slidably move the plurality of frames.

Referring first to the plurality of slides, as shown in FIG. 2, a pair of first slides 310a, a pair of second slides 310b, a pair of third slides 310c and a pair of fourth slides 310d are configured in such a manner as to be coupled correspondingly to the leg region frame portion 201, the thigh region frame portion 202, the hip region frame portion 203 and the upper body region frame portion 204. On the other hand, the first to fourth slides 310a, 310b, 310c and 310d have horizontal bearings 311a and vertical bearings 311b mounted at every corner thereof.

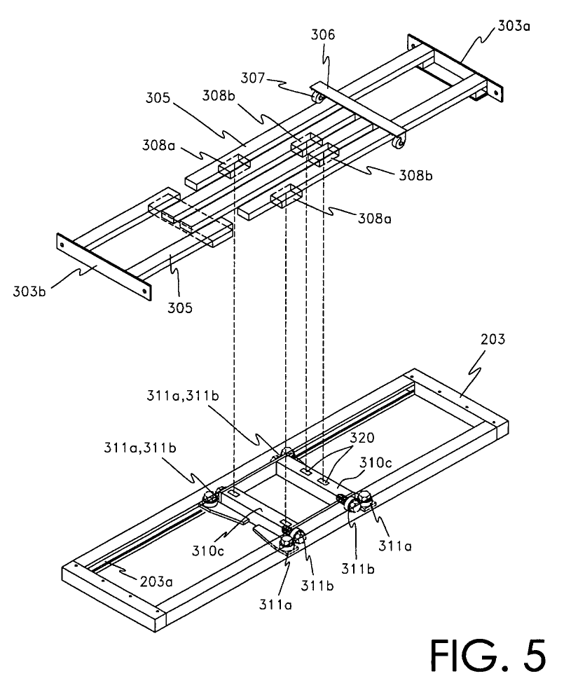

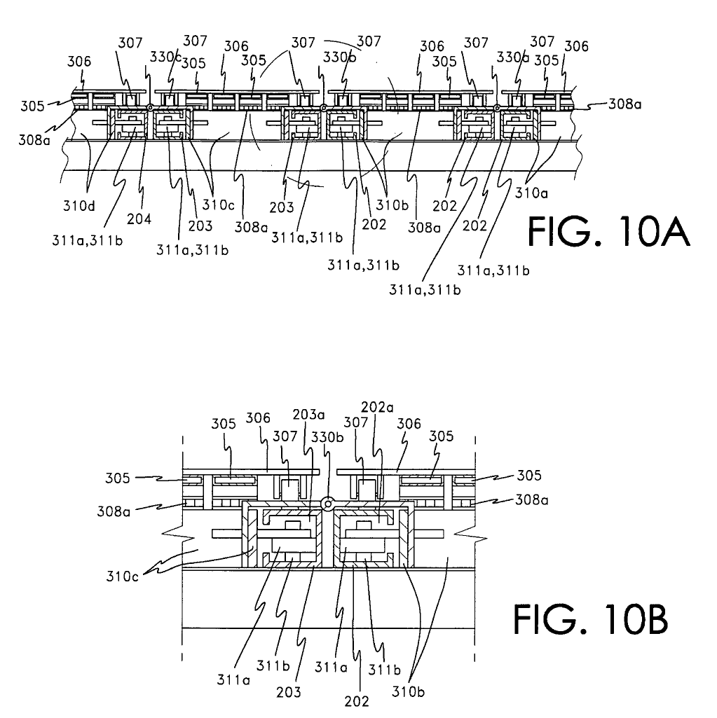

The first slides 310a having the horizontal bearings 311a and the vertical bearings 311b are coupled to the leg region frame portion 201, the second slides 310b to the thigh region frame portion 202, the third slides 310c to the hip region frame portion 203, and the fourth slides 310d to the upper body region frame portion 204. As shown in detail in FIGS. 5, 5, 10A and 10B, the horizontal bearings 311a and the vertical bearings 311b are insertedly coupled to guide spaces 201a, 202a and 203a formed along the respective frame portions 202, 203 and 204.

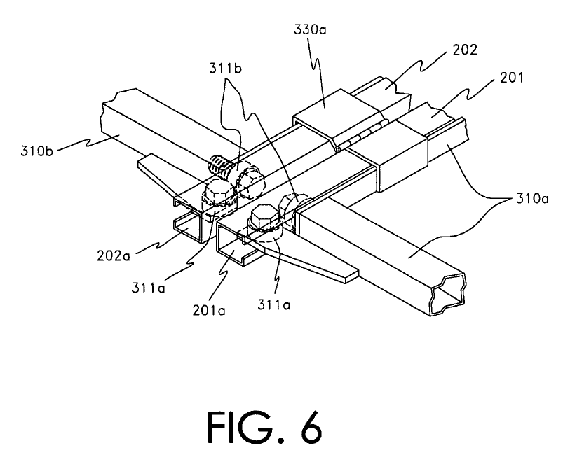

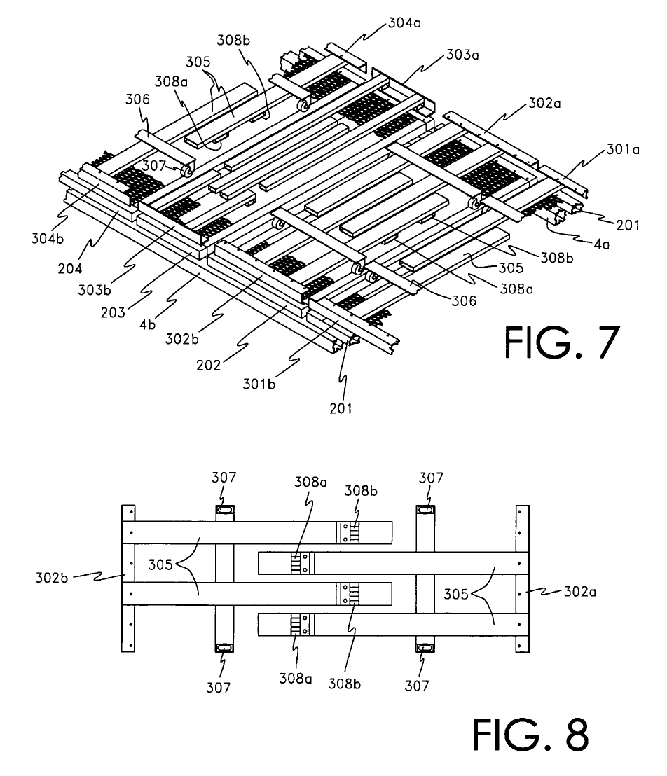

The first slides 310a, the second slides 310b, the third slides 310c and the fourth slides 310d are connected to one another so as to conduct the sliding movements in concert, without being slidingly moved individually, and thus, as shown in FIGS. 6, 10A and 10B, the first slides 310a are connected to the second slides 310b by means of a slide-connecting hinge 330a, the second slides 310b to the third slides 310c by means of a slide-connecting hinge 330b, and the third slides 310c to the fourth slides 310d by means of a slide-connecting hinge 330c. Under the above-mentioned connected state, when the third slides 310c that receives power is moved to any side, the first slides 310a, the second slides 310b and the fourth slides 310d connected to the third slides 310c are moved to the same side as the third slides 310c.

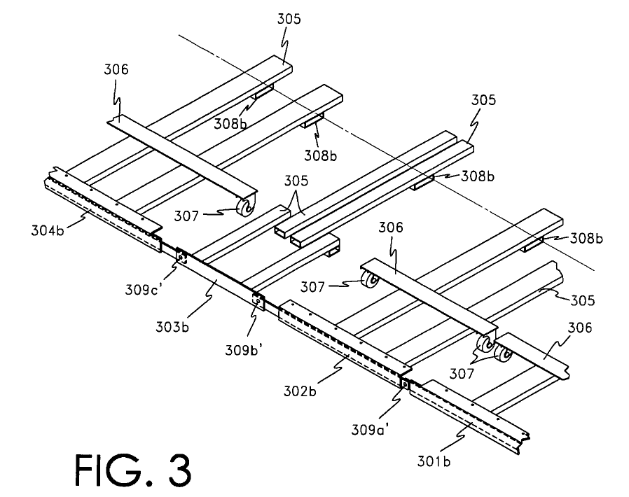

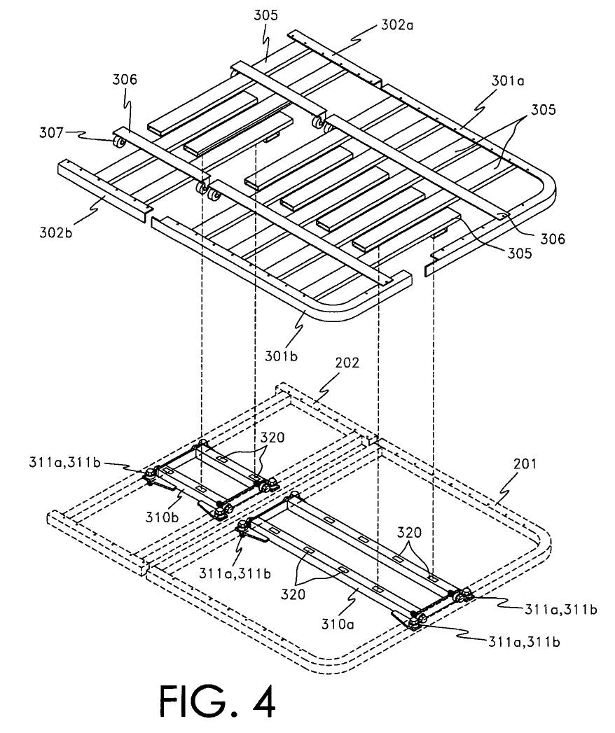

Next, as shown in FIGS. 4 and 5, the first to fourth slides 310a, 310b, 310c and 310d have a plurality of hinge-connecting parts 320 formed at given regular intervals on the top surfaces thereof, and thus, a plurality of mattress support members 305 are coupled correspondingly to the hinge-connecting parts 320 by means of hinges 308a and 308b formed on the undersides thereof. At this time, as shown in FIGS. 3, 4, 5 and 9, each mattress support member is formed of a bar having a given width and thickness, and they are spaced apart from one another by a given distance. The plurality of mattress support members 305 are articulatedly coupled to one another by the respective sections, as shown in FIG. 2.

Next, the plurality of mattress support members 305 are configured on the four sections including the leg region, the thigh region, the hip region, and the upper body region so as to confirm to the four region frame portions of the second frame 200, and the four sections are subdivided into two sub-sections. That is, the leg region section is subdivided into the right leg region frame portion 301a, the left leg region frame portion 301b, the thigh region section into the right thigh region frame portion 302a and the left thigh region frame portion 302b, the hip region section into the right hip region frame portion 303a and the left hip region frame portion 303b, and the upper body region section into the right upper body region frame portion 304a and the left upper body region frame portion 304b.

On the other hand, as shown in FIGS. 3, 4 and 5, the frame portions by the respective sections are connected to one another, at the states where the mattress support members 305 have the hinges 308a and 308b mounted on the free ends thereof and a plurality of connecting plates 306 adapted to connect the mattress support members 305 to one another have a guide roller 307 mounted on the both side end portions of the undersides thereof. That is, as shown in FIG. 2, the right leg region frame portion 301a is coupled to the right thigh region frame portion 302a by means of a hinge 309a, the right hip region frame portion 303a to the right thigh region frame portion 302a by means of a hinge 309b, and the right upper body region frame portion 304a to the right hip region frame portion 303a by means of a hinge 309c. In the same manner as mentioned above, the left leg region frame portion 301b is coupled to the left thigh region frame portion 302b by means of a hinge 309a′, the left hip region frame portion 303b to the left thigh region frame portion 302b by means of a hinge 309b′, and the left upper body region frame portion 304b to the left hip region frame portion 303b by means of a hinge 309c′.

After that, the right leg region frame portion 301a and the left leg region frame portion 301b are coupled to the hinge-connecting parts 320 of the first slides 310a such that the hinges mounted on the free ends of the undersides of the plurality of mattress support members 305 are arranged in a zigzag manner. In the same manner as mentioned above, the right thigh region frame portion 302a and the left thigh region frame portion 302b are coupled to the hinge-connecting parts 320 of the second slides 310b, the right hip region frame portion 303a and the left hip region frame portion 303b to the hinge-connecting parts 320 of the third slides 310c, and the right upper body region frame portion 304a and the left upper body region frame portion 304b to the hinge-connecting parts 320 of the fourth slides 310d.

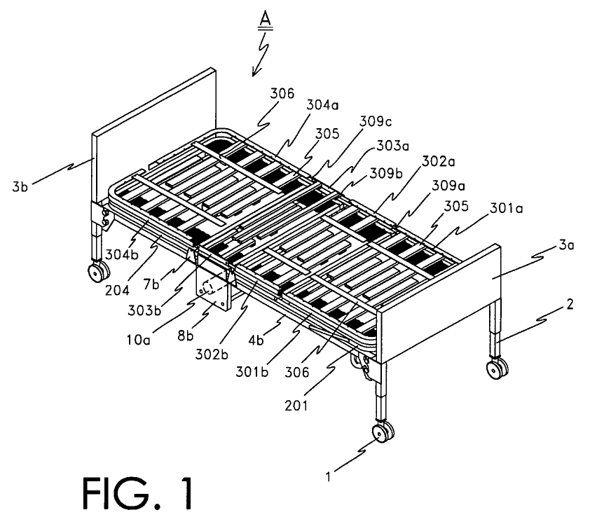

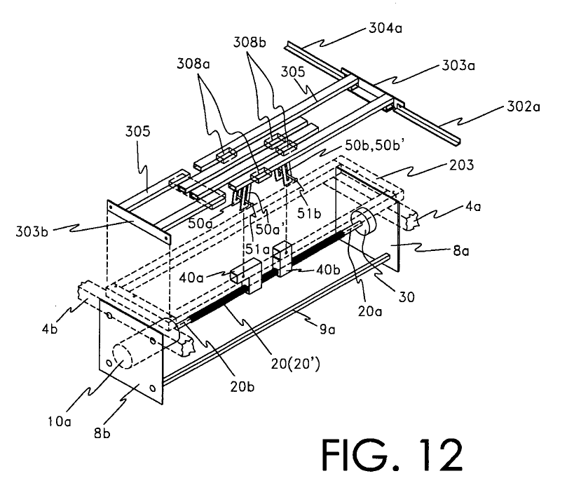

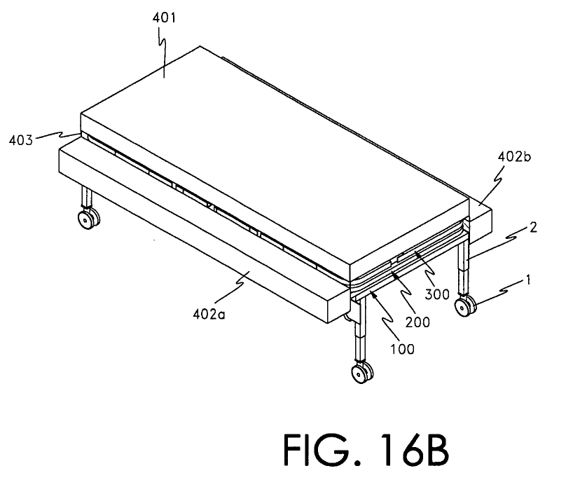

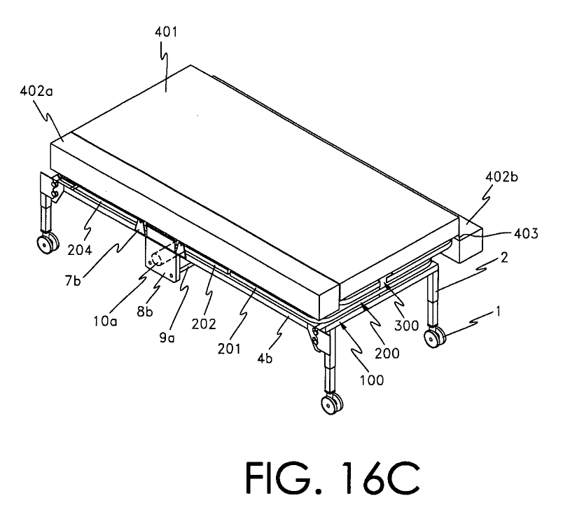

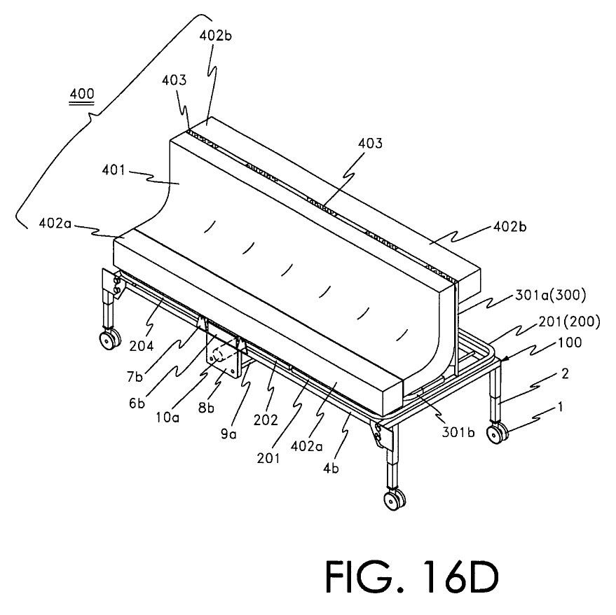

Next, as shown in FIGS. 12, 13A, 13B, 13C and 14, the right hip region frame portion 303a and the left hip region frame portion 303b have lifting links 50a and 50b mounted at given positions of the undersides thereof, the lifting links 50a and 50b being coupled to the right moving piece 40a and the left moving piece 40b by means of hinge pins 51a and 51b. As a result, as shown in FIG. 1, the bed frame assembly A for the use of the articulating bed that is slidingly moved to extend by a given width and to lift the slidingly moved area, and the mattress assembly 400 is mounted on the top surface of the bed frame assembly A, as shown in FIGS. 16A and 16B.

Now, the mattress assembly 400 will be explained. As shown in FIG. 16A, a main mattress 401 is located on the center portion thereof and a pair of outside mattresses 402a and 402b are coupled to the both sides of the main mattress 400 in such a manner as to be freely movable.

At this time, the main mattress 401 has the same width and length as the third frame 300, and even though the thickness of the main mattress 401 depends upon a mattress material, it is desirably within a range of about 3 inches. However, the outside mattresses 402a and 402b have the width within the range of about 8 inches and have the same length as the main mattress 401. And, the thickness of each outside mattress is about 5 inches or more. On the other hand, the outside surfaces of the main mattress 401 and the outside mattresses 402a and 402b are covered with fabric or synthetic leather.

The first reason why the outside surfaces of the main mattress 401 and the outside mattresses 402a and 402b are covered with fabric or synthetic leather is that a plurality of strings (which are not shown) for fixedly tying the main mattress 401 to the third frame 300 should be mounted on the main mattress 401, and the second reason is that the outside mattresses 402a and 402b are detachably mounted freely on the main mattress 401 by means of sewing, buttons, or Velcro means. The main mattress 401 and the outside mattresses 402a and 402b are connected by means of a plurality of band-like bridges 403 in such a manner as to be spaced apart from each other by a given distance, and they are coupled on the top surface of the third frame 300.

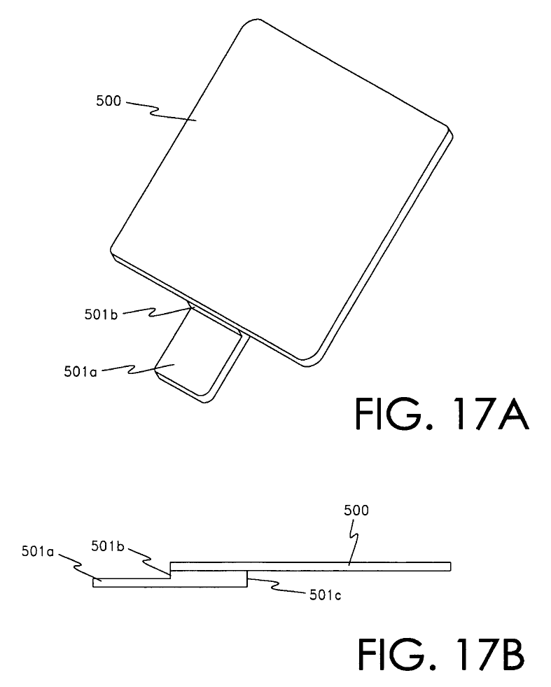

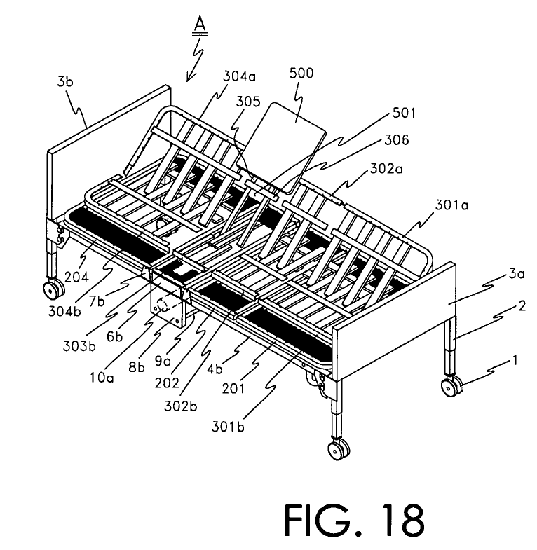

When a patient is moved from the articulating bed to a given place, or when a patient sits on the articulating bed, moreover, the headrest 500 is used to support the patient's head. At this time, as shown in FIGS. 17A and 17B, the headrest 500 includes a relatively large base plate 500a adapted to support the patient's head, an insertion portion 501a extended outwardly from the center portion of the bottom side of the underside of the base plate 500a in such a manner as to be relatively thick at one side attached on the base plate 500a and relatively thin at the other side thereto, and perpendicular locking projections 501b and 501c formed integrally with the insertion portion 501a.

Now, an explanation of the articulating bed where the bed frame assembly A, the mattress assembly 400 and the headrest 500 are coupled to one another will be given.

First, the main mattress 401 of the mattress assembly 400 is mounted on the top surface of the third frame 300 of the bed frame assembly A in such a way of tying the plurality of strings mounted uniformly on the underside of the main mattress 401 to the mattress support members 305 and the connecting plates 306 of the third frame 300, thereby enabling the mattress assembly 400 and the bed frame assembly A to be operated as a single structure.

If the main mattress 401 is tied up to the third frame 300, the outside mattresses 402a and 402b of the mattress assembly 400 coupled to the both sides of the main mattress 401 are opened to the both outsides of the mattress assembly 400.

The articulating bed coupled to the mattress assembly 400 is operated in accordance with the functions selected by a user by means of the control switch (not shown), and in this case, the functions include initial state, right sliding movement and original position returning, right area lifting and original position returning, left sliding movement and original position returning, left area lifting and original position returning, and four section articulating and original position returning. If a left sliding button is pressed by means of the manipulation of the control switch, power is applied to the motor 10a to rotate the screw shaft 20 in a clockwise direction.

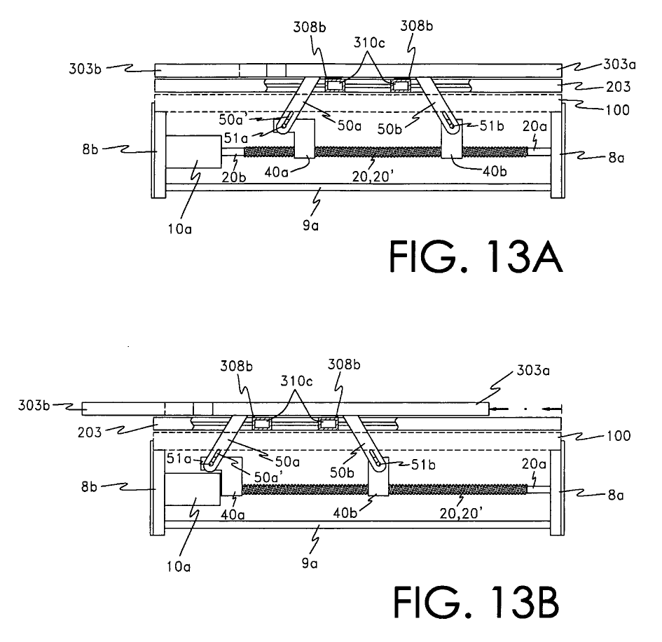

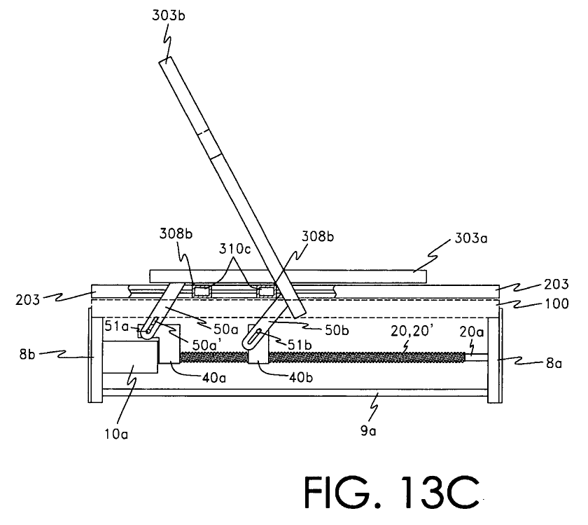

The screw shaft 20 rotates at its fixed position such that the right moving piece 40a and the left moving piece 40b are moved from the initial state as shown in FIG. 13A slowly to a left side thereof as shown in FIG. 13B, under the locking principle of the bolts and nuts, and at this time, the hinge pins 51a and 51b are inserted into the right moving piece 40a and the left moving piece 40b such that the right hip region frame portion 303a and the left hip region frame portion 303b connected by means of the lifting links 50a and 50b to the right moving piece 40a and the left moving piece 40b are simultaneously slidingly moved to the left side thereof.

As described above, on the other hand, the right hip region frame portion 303a and the left hip region frame portion 303b are connected at one sides thereof to the right upper body region frame portion 304a and the left upper body region frame portion 304b by means of the hinges 309c and 309c′, and connected at the other sides thereof to the right thigh region frame portion 302a and the left thigh region frame portion 302b by means of the hinges 309b and 309b′. Further, the right thigh region frame portion 302a and the left thigh region frame portion 302b are connected to the right leg region frame portion 301a and the left leg region frame portion 301b by means of the hinges 309a and 309a′, thereby constituting a single frame. Thus, if the right hip region frame portion 303a and the left hip region frame portion 303b are slidingly moved, the entire frame portions are moved simultaneously in concert.

Moreover, the third frame 300 is coupled to the first slides 310a, the second slides 310b, the third slides 310c and the fourth slides 310d by means of the hinges 308a and 308b, and the first slides 310a, the second slides 310b, the third slides 310c and the fourth slides 310d are connected to one another by means of slide-connecting hinges 330a, 330b and 330c, such that if the right hip region frame portion 303a and the left hip region frame portion 303b are slidingly moved, the third frame 300 and the first to fourth slides coupled to one another are slidingly moved from one sides of the first frame 100 and the second frame 200 in such a manner as to be protruded to the left side thereof, as shown in FIG. 13B.

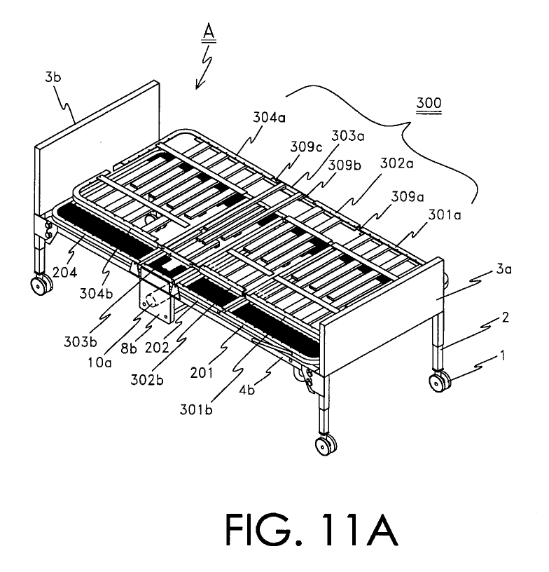

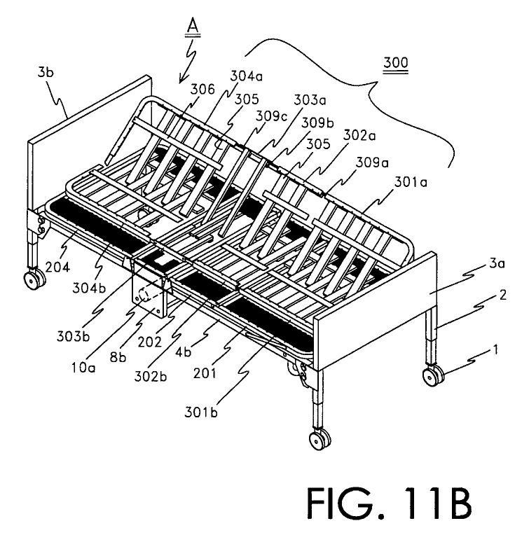

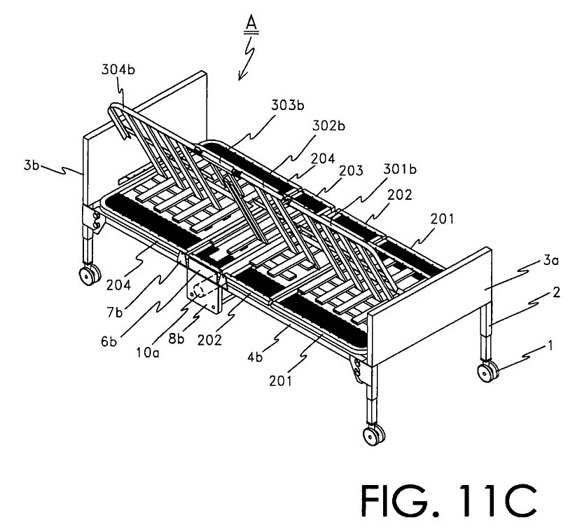

On the other hand, FIG. 11A shows the bed frame assembly A after the sliding movement is finished, and FIG. 16C shows the bed frame assembly A coupled to the mattress assembly 400 after the sliding movement.

As mentioned above, the main mattress 401 adapted to be placed on the top surface of the third frame 300 of the bed frame assembly A is fixedly by means of the plurality of strings mounted thereon to the mattress support members 305 and the connecting plates 306 on the top surface of the third frame 300.

Since the outside mattress 402a is relatively freely movable without any tying, however, it is pulled by means of the bridges 402 connected thereto when the main mattress 401 is moved by the movement of the third frame 300 and is raised on the upper surface of the second frame 200 exposed by the moving distance of the third frame 300, with a result of being brought into close contact with the main mattress 401, as shown in FIG. 16C.

At this state, if the right region lifting switch is pressed, the power is applied to the motor 10a, and the motor 10a is driven. The driving force is applied to the screw shaft 20, thereby causing the screw shaft 20 to be rotated. As the screw shaft 20 is rotated, the left moving piece 40b escapes from the screw 20′ and is pushed toward the idle portion 20b formed along the right end portion of the screw shaft 20.

As the screw shaft 20 is kept rotating, thus, the right moving piece 40a is moved to approach the left moving piece 40b being stopped, and at a returning time point during this process, the lifting link 50a is moved down like a circle by means of the hinge pin 51a operating by the guide of a longitudinal hole 50a′.

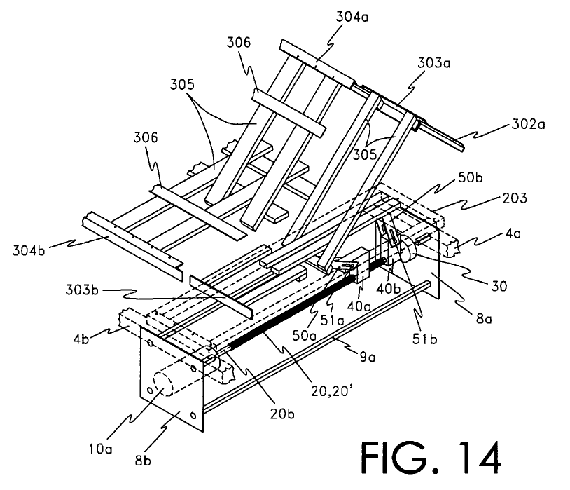

Under the above process, the right section of the third frame 300 that has been slidingly moved is lifted to one side thereof, as shown in FIG. 16D. The main parts operating during the lifting operation are illustrated in FIG. 14, and the lifting operation of the third frame 300 having the mattress assembly 400 mounted thereon is illustrated in FIG. 16D. On the other hand, an operation for returning to its original position after the lifting operation is carried out in the reverse order thereto.

On the other hand, the sliding and lifting operations are conducted with respect to the third frame 300 adapted to turn the patient lying on the bed over, and hereinafter, an explanation on the articulating operations in the four sections of the articulating bed according to the present invention will be given.

The articulating operations in the four sections of the bed are needed when the patient wants to sit on the bed, and in this case, if a four section-articulating switch is pressed, power is applied to the motor 10b. Thus, the push shaft 11 is rotated by the driving force of the motor 10b.

The rotation of the push shaft 11 enables rotating of the links (not shown) connected at the center and end portions of the push shaft 11 to the upper body region frame portion 204 and the thigh region frame portion 202, such that the upper body region frame portion 204 and the thigh region frame portion 202 of the second frame 200 connected by means of the hinge pins 7b′ and 5b′, as shown in FIG. 9, are lifted at the end portions thereof. This lifting operation enables the third frame 300 coupled on the top surface of the second frame 200 to be operated. As shown in FIG. 15, the four sections on the third frame 300 are articulatedly operated, and the operation of returning to the original position after the articulating operation is carried out in the reverse order thereto.

Hereinafter, an explanation on the operations of the articulating bed according to the present invention at various cases the patient has had will be given. The first case is when the patient is moved from the bed to a wheelchair, and the second case is when he changes his clothes or bed sheet 600 with new one, or when his position on the bed is changed to provide refresh air to him, or when he has massage care or bed sore care.

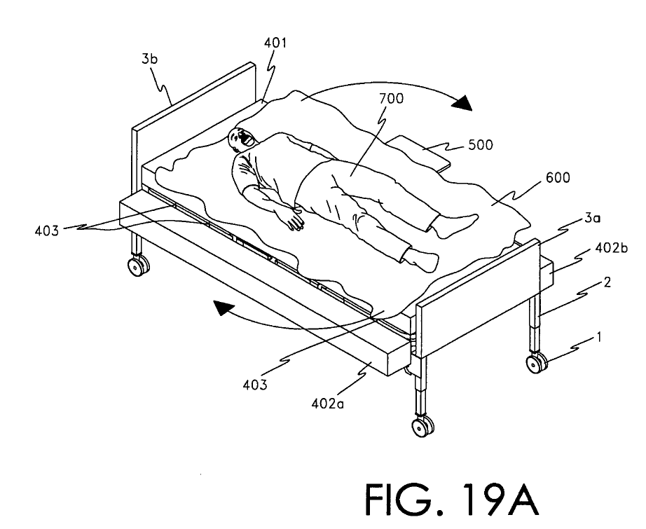

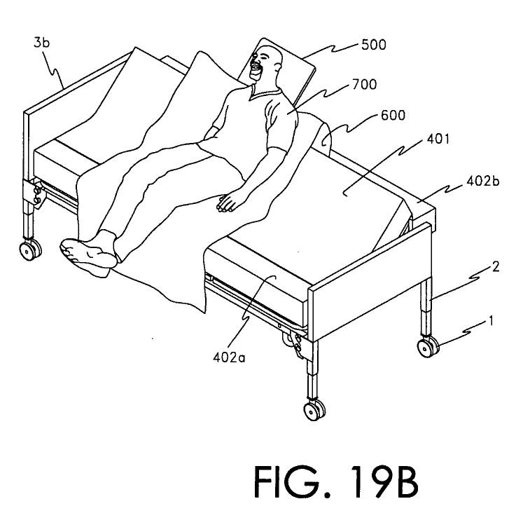

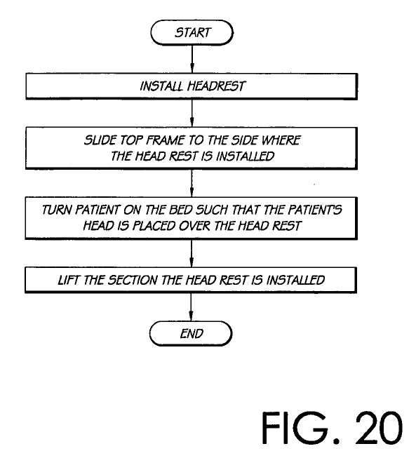

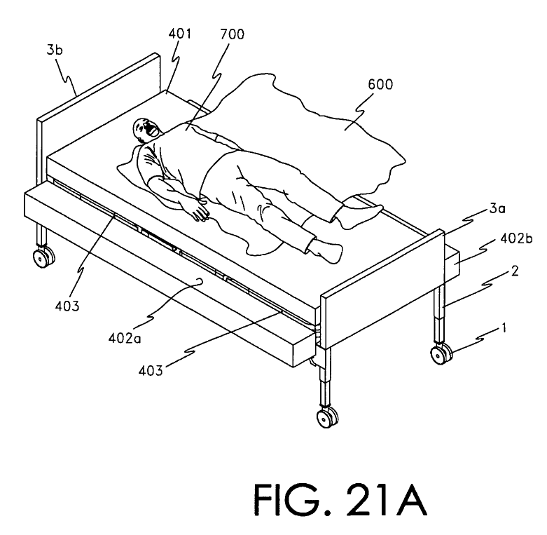

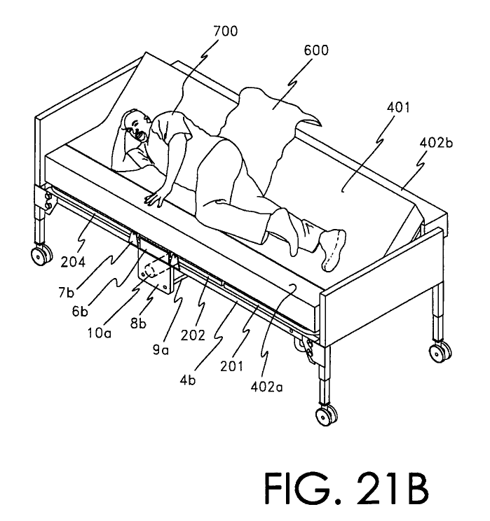

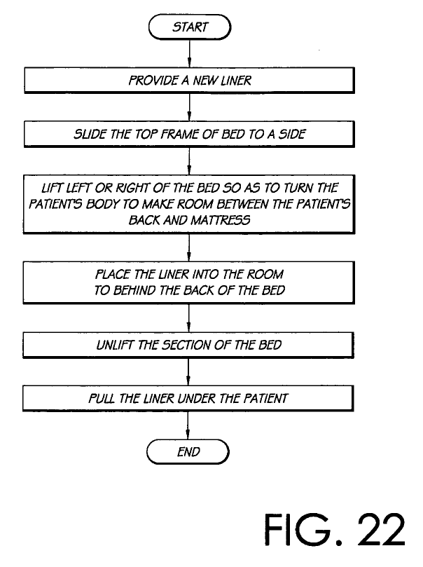

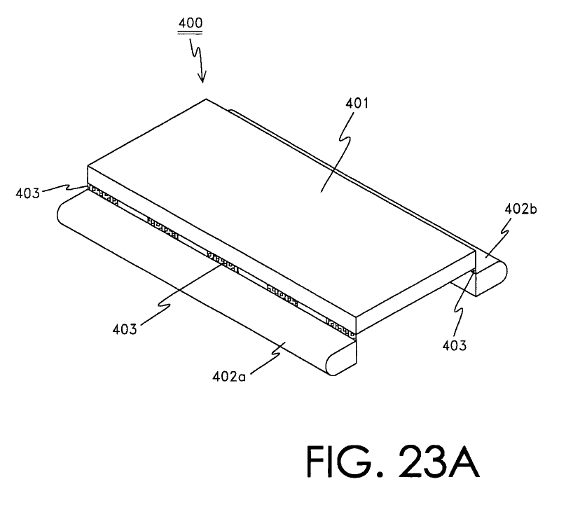

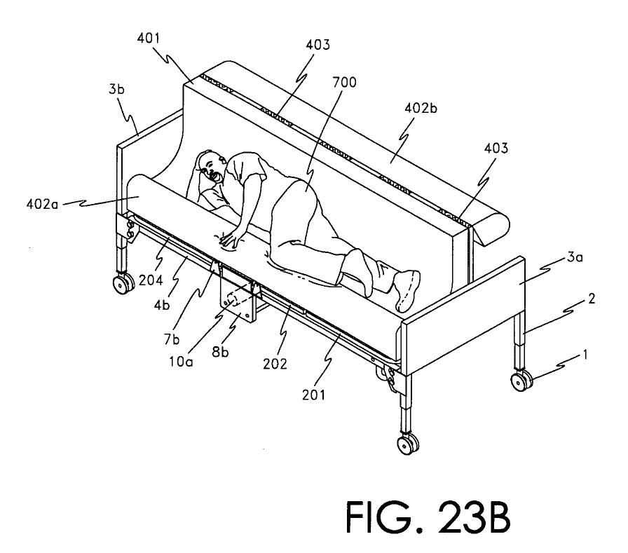

As the first case, the patient is moved from the bed to the wheelchair so as to take a walk or have medical treatment at another place. In this case, as shown in FIG. 19A, the insertion part 501a of the headrest 500 is inserted under the main mattress 401 so as not to be separated from the bed.

At this time, the coupling of the insertion part 501a of the headrest 500 is carried out in the direction where the third frame 300 or the mattress assembly 400 is slidingly moved, and the position to be mounted thereof is where the patient's head is placed. That is, the position is either the right hip region frame portion 303a or the left hip region frame portion 303b, or either the right thigh region frame portion 302a or the left thigh region frame portion 302b.

At this time, if the headrest 500 is mounted on the right hip region frame portion 303a, the insertion part 501a of the headrest 500 is inserted between the mattress support members 306 located at the both sides thereof such that the locking projections 501b and 501c are fixedly locked to the connecting plates 306 and the edge frame.

As noted above, the mattress assembly 400 and the bed frame assembly A are operated as a single structure. In more detail, the main mattress 401 is tied up to the third frame 300, and the outside mattresses 402a and 402b coupled like wings at the both sides of the main mattress 401 are connected by means of the bridges 403 to the main mattress 401, without any tying or fixing, in an outwardly opened state.

At this state, therefore, the articulating bed is operated in accordance with the functions selected by a user by means of the control switch. The functions of the control switch include ‘initial state’, ‘right sliding movement and original position returning’, ‘right region lifting and original position returning’, ‘left sliding movement and original position returning’, ‘left region lifting and original position returning’, and ‘four section articulating and original position returning’ At the initial state of the control switch if the sliding movement button to the right side at which the headrest 500 is coupled is pressed, power is applied to the motor 10a to rotate the screw shaft 20 in a counterclockwise direction. The rotation direction described in the present invention is just one example, and therefore, the rotation directions or sliding methods are not limited to as described herein.

The screw shaft 20 is rotated at its fixed position such that the right moving piece 40a and the left moving piece 40b are moved slowly to the right sides thereof, as shown in FIG. 13B, under the locking principle of the bolts and nuts, and at this time, the hinge pins 51a and 51b are inserted into the right moving piece 40a and the left moving piece 40b such that the right hip region frame portion 303a and the left hip region frame portion 303b connected by means of the lifting links 50a and 50b to the right moving piece 40a and the left moving piece 40b are simultaneously slidingly moved to the right sides thereof.

As described above, on the other hand, the right hip region frame portion 303a and the left hip region frame portion 303b are connected at one sides thereof to the right upper body region frame portion 304a and the left upper body region frame portion 304b by means of the hinges 309c and 309c′, and connected at the other sides thereof to the right thigh region frame portion 302a and the left thigh region frame portion 302b by means of the hinges 309b and 309b′. Further, the right thigh region frame portion 302a and the left thigh region frame portion 302b are connected to the right leg region frame portion 301a and the left leg region frame portion 301b by means of the hinges 309a and 309a′, thereby constituting the third frame 300 as a single frame. Thus, if the right hip region frame portion 303a and the left hip region frame portion 303b are slidingly moved, the third frame 300 and the mattress assembly 400 are moved simultaneously in concert.

While the sliding movement is being conducted, a plurality of guide rollers 307 mounted on the connecting plates 306 of the third frame 300 are rolled by the guide of the second frame 200 supporting the undersides of the third frame 300, and at the same time, the horizontal bearings 311a and the vertical bearings 311b of the first to fourth slides 310a, 310b, 310c and 310d are rolled along the guide spaces 201a, 202a, 203a and 204a of the second frame 200 on which the plurality of guide rollers 307 are rolled, thereby enabling the sliding movement of the first to fourth slides 310a, 310b, 310c and 310d to be balanced.

Moreover, the third frame 300 is coupled to the first slides 310a, the second slides 310b, the third slides 310c and the fourth slides 310d by means of the hinges 308a and 308b, and the first slides 310a, the second slides 310b, the third slides 310c and the fourth slides 310d are connected to one another by means of the slide-connecting hinges 330a, 330b and 330c.

Thus, if the right hip region frame portion 303a and the left hip region frame portion 303b are slidingly moved, the third frame 300 and the first to fourth slides 310a to 310d coupled to one another are slidingly moved from one sides of the first frame 100 and the second frame 200 in such a manner as to be protruded to the right side thereof, as shown in FIG. 13B.

The bed frame assembly A after the sliding movement is finished is illustrated in FIG. 11A, and the bed frame assembly A coupled to the mattress assembly 400 after the sliding movement is illustrated in FIG. 16C.

As mentioned above, the main mattress 401 adapted to be placed on the top surface of the third frame 300 of the bed frame assembly A is fixedly by means of the plurality of strings mounted thereon to the mattress support members 305 and the connecting plates 306 on the top surface of the third frame 300, but since the outside mattress 402a is relatively freely movable without any tying, however, it is pulled by means of the bridges 402 connected thereto when the main mattress 401 is moved by the movement of the third frame 300 and is raised on the upper surface of the second frame 200 exposed by the moving distance of the third frame 300, with a result of being brought into close contact with the main mattress 401, as shown in FIG. 16C.

At this state, if the bed sheet is to be changed with new bed sheet 600, first, the sheet at the left side outside mattress 402a of the patient 700 is pushed to the patient's body left side and next, the new bed sheet 600 is pushed to the patient body side. At this state, the right region lifting button of the control switch is pressed.

At this time, the power is applied to the motor 10a being stopped, and the motor 10a rotates the screw shaft 20. As the screw shaft 20 is rotated, the left moving piece 40b escapes from the screw 20′ and is pushed toward the idle portion 20b formed along the right end portion of the screw shaft 20. As the screw shaft 20 is kept rotating, thus, the right moving piece 40a is moved to approach the left moving piece 40b being stopped.

At a returning time point during this process, the lifting link 50a is moved down like a circle by means of the hinge pin 51a operating by the guide of the longitudinal hole 50a′.

Under the above process, the right section of the third frame 300 that has been slidingly moved is lifted to one side thereof, as shown in FIG. 16D. In the lifting process, the body of the patient 700 is rolled and turned to a side.

At this state, a space between the back of the patient body and the mattress 401 is formed such that only if the body of the patient 700 is pushed a little forwardly, the old bed sheet remaining on one side of the patient 700 is completely removed from the bed and at the same time, the new bed sheet 600 is partially spread under the patient 700.

At this time, therefore, only if the new bed sheet 600 is pulled in one side direction, it is completely spread on the bed with ease.

The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements.

This disclosure is thus meant to be understood to include what is specifically illustrated and described above, what is conceptually equivalent, what can be obviously substituted, and also what incorporates the essential ideas. The scope of this description is to be interpreted only in conjunction with the appended claims and it is made clear, here, that each named inventor believes that the claimed subject matter is what is intended to be patented.

As mentioned above, there is provided the articulating bed of the present invention that has the third frame 300 slidingly moved automatically to left or right sides as the power from the motor 10a, the screw shaft 20, and the right moving piece 40a and the left moving piece 40b is applied to the third frame 300, such that the slidingly moved section of the third frame 300 is lifted to turn the patient to a side.

As described above, the sliding movement of the third frame 300 and the formation of the outside mattress 402a are aimed to form a space exposed at one side of the bed by the movement of the third frame 300 and to locate the outside mattress 402a on the space exposed, thereby extending the bed width. Thus, the nurse easily turns the patient lying on the bed over, even though he or she does not forcedly push or pull the patient.

In addition, at a state where the third frame 300 is slidingly moved to extend the bed by a given width, it is lifted to turn the patient lying on the bed over. In this case, the patient is turned not by the physical force of the nurse, but by the automatic device according to mechanical principles, and therefore, even if the patient is heavy, he is easily turned over on the bed. Since the patient lying on the center portion of the bed is moved to the outside thereof just by the lifting operation of the third frame, the nurse comfortably looks after the patient when massages or treats him, without any bending their body toward the inside of the bed.

Moreover, the mattress assembly 400 of the present invention is mounted on the frame assembly A in a state where the outside mattresses 402a and 402b are connected by means of the plurality of bridges 403 to the main mattress 401, and in this case, when the third frame 300 is slidingly moved to any direction, the outside mattress at the pushing side falls down under the third frame 300 and contrarily the outside mattress at the pulling side is located on the space exposed by the slidingly moving distance of the third frame 300, thereby enabling the bed width to be extended larger.

In addition, the patient is exposed at fresh air while he is taking a long rest at a state where he is turned laterally, and further, during this time, the mattress is sufficiently ventilated.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An articulating bed slidingly movable to extend by a given width and to lift the slidingly moved area thereof, wherein a first frame is configured as a base frame by coupling four legs and a pair of main bars for fixing the four legs, the main bars having stationary plates extended from the upper surfaces of the respective central portions thereof so as to prevent a hip region frame portion of a second frame from being moved, the stationary plates having hinge-fixing plates mounted on the respectively both sides thereof so as to couple a thigh region frame portion to an upper body region frame portion by means of a hinge pin and to couple the thigh region frame portion to a leg region frame portion by means of a hinge pin formed at one side surface thereof;
wherein first slides, second slides, third slides and fourth slides each having a plurality of horizontal bearings and a plurality of vertical bearings adapted to provide sliding movements are mounted on the leg region frame portion, the thigh region frame portion, the hip region frame portion and the upper body region frame portion, a right leg region frame portion and a left leg region frame portion are located on the top surfaces of the first slides, a right thigh region frame portion and a left thigh region frame portion are on the top surfaces of the second slides, a right hip region frame portion and a left hip region frame portion are on the top surfaces of the third slides, and a right upper body region frame portion and a left upper body region frame portion are on the top surfaces of the fourth slides, a hinge is mounted on the end portions of the undersides of a plurality of mattress support members constituting the respective frame portions such that the third frame is articulated, and a guide roller is mounted on the end portions of the undersides of the both sides of a plurality of connecting plates fixing the mattress support members in such a manner as to be smoothly slid against the respective slides;
wherein the right leg region frame portion is coupled to the right thigh region frame portion by means of a first hinge, the right hip region frame portion to the right thigh region frame portion by means of a second hinge, the right upper body region frame portion to the right hip region frame portion by means of a third hinge, the left leg region frame portion to the left thigh region frame portion by means of a fourth hinge, the left hip region frame portion to the left thigh region frame portion by means of a fifth hinge, and the left upper body region frame portion to the left hip region frame portion by means of a sixth hinge, whereby the articulating bed is articulated to four sections in the forward and backward directions thereof and articulated to the two stages in the left and right directions thereof so as to lift the slidingly moved area of the third frame;
wherein the main bars of the first frame have driving device plates mounted on the undersides thereof, the driving device plates having a pair of fixing bars mounted transversely on the both bottom sides of the underside thereof and a screw shaft mounted transversely at the inner surfaces thereof, the screw shaft having an idle portion formed along the end portions of the both sides thereof, a screw formed along the entire length thereof, and a right moving piece and a left moving piece coupled along the screw shaft in such a manner as to be moved in the left or right direction by the rotating screw when the screw shaft is rotated, the right moving piece and the left moving piece being coupled to the right hip region frame portion and the left hip region frame portion through lifting links coupled by means of hinge pins, a motor is mounted on one side of the screw shaft and has a control switch adapted to rotate the screw shaft, and a push shaft is mounted in a perpendicular direction to the screw shaft so as to articulate the four sections of the bed in the forward and backward directions thereof;
wherein a mattress assembly is configured such that a main mattress has the same length and width as the third frame and a pair of outside mattresses have the same length as the main mattress, the same width as the slidingly moving width of the third frame and a height higher (by about 2 inches) than the third frame at the bottom surfaces therebetween, the outside mattresses being located at the both sides of the main mattress in such a manner as to be connected by means of a plurality of band-like bridges made of fabric, synthetic resin or leather; and
wherein a headrest is fixedly coupled to the third frame so as to support a patient's head when the patient sits on the bed for the movement of other places, whereby the articulating bed is articulated to four sections in the forward and backward directions thereof and slidingly moved in the left and right directions thereof so as to extend the bed width and lift the sliding moved area of the third frame, thereby moving or turning the patient lying on the bed.

2. The articulating bed and the mattress for the articulating bed according to claim 1, wherein the first frame is configured as the base frame by coupling the four legs, the pair of main bars for fixing the four legs, and a pair of fixing bars located between the pair of main bars to one another;
wherein the first slides, the second slides, the third slides and the fourth slides each having the horizontal bearings and the vertical bearings are mounted on the first frame in such a manner as to be slidingly movable in the left and right directions, the right thigh region frame portion, the left thigh region frame portion, the right hip region frame portion, the left hip region frame portion, the right upper body region frame portion and the left upper body region frame portion are mounted on the top surfaces of the first slides, the second slides, the third slides and the fourth slides, the hinge is mounted on the end portions of the undersides of the mattress support members constituting the respective frame portions such that the third frame is articulated, and the guide roller is mounted on the end portions of the undersides of the both sides of the connecting plates fixing the mattress support members in such a manner as to be smoothly slid against the respective slides;
wherein the right leg region frame portion is coupled to the right thigh region frame portion by means of the first hinge, the right hip region frame portion to the right thigh region frame portion by means of the second hinge, the right upper body region frame portion to the right hip region frame portion by means of the third hinge, the left leg region frame portion to the left thigh region frame portion by means of the fourth hinge, the left hip region frame portion to the left thigh region frame portion by means of the fifth hinge, and the left upper body region frame portion to the left hip region frame portion by means of the sixth hinge, whereby the articulating bed is articulated to four sections in the forward and backward directions thereof and articulated to the two stages in the left and right directions thereof so as to lift the slidingly moved area of the third frame;
wherein the mattress assembly is configured such that the main bars of the first frame have the driving device plates mounted on the undersides thereof, the driving device plates having the fixing bars mounted transversely on the both bottom sides of the underside thereof and the screw shaft mounted transversely at the inner surfaces thereof, the screw shaft having the idle portion formed along the end portions of the both sides thereof, the screw formed along the entire length thereof, and the right moving piece and the left moving piece coupled along the screw shaft in such a manner as to be moved in the left or right direction by the rotating screw when the screw shaft is rotated, the right moving piece and the left moving piece being coupled to the right hip region frame portion and the left hip region frame portion through lift links coupled by means of hinge pins, the motor is mounted on one side of the screw shaft and has the control switch adapted to rotate the screw shaft, and the push shaft is mounted in a perpendicular direction to the screw shaft so as to articulate the four sections of the bed in the forward and backward directions thereof;
wherein the main mattress has the same length and width as the third frame, the outside mattresses have the same length as the main mattress, the same width as the slidingly moving width of the third frame, and a height higher (by about 2 inches) than the third frame at the bottom surfaces therebetween, and the outside mattresses are located at the both sides of the main mattress in such a manner as to be connected by means of the plurality of band-like bridges made of fabric, synthetic resin or leather; and
wherein the headrest is fixedly coupled to the third frame so as to support the patient's head when the patient sits on the bed for the movement of other places, whereby the articulating bed is articulated to four sections in the forward and backward directions thereof and slidingly moved in the left and right directions thereof so as to extend the bed and lift the slidingly moved area of the third frame, thereby moving or turning the patient lying on the bed.

3. The articulating bed and the mattress for the articulating bed according to claim 1, wherein the right leg region frame portion is coupled to the right thigh region frame portion by means of the first hinge, the right hip region frame portion to the right thigh region frame portion by means of the second hinge, the right upper body region frame portion to the right hip region frame portion by means of the third hinge, the left leg region frame portion to the left thigh region frame portion by means of the fourth hinge, the left hip region frame portion to the left thigh region frame portion by means of the fifth hinge, and the left upper body region frame portion to the left hip region frame portion by means of the sixth hinge; and
wherein the right hip region frame portion and the left hip region frame portion have lifting links mounted at given positions of the undersides thereof, the lifting links being coupled by means of first and second hinge pins to the right moving piece and the left moving piece being moved in a left or right side along the screw shaft having the idle portions formed at the both sides thereof, whereby the articulating bed is articulated to four sections in the forward and backward directions thereof and slidingly moved in the left and right directions thereof so as to extend the bed and lift the slidingly moved area of the third frame, thereby moving or turning the patient lying on the bed.

4. The articulating bed and the mattress for the articulating bed according to claim 1, wherein the third frame is slidingly movable to the right or left side according to a user's selection so as to extend the articulating bed by the given width, and articulated in a lengthwise direction to the four sections and in a width direction to left and right sections such that when one side section is lifted, the other side section is maintained at a horizontal state;
wherein the mattress assembly is configured such that the outside mattresses are connected by means of the plurality of bridges to the both sides of the main mattress located on the center portion of the mattress assembly and when the third frame is slidingly moved to any one direction, the outside mattress located at the pulling side is mounted on the space exposed on the second frame by the slidingly moved area of the third frame to extend the articulating bed by the given width; and
wherein the headrest is fixedly coupled to the third frame so as to support the patient's head when the patient sits on the bed for the movement of other places, whereby the articulating bed is articulated to four sections in the forward and backward directions thereof and slidingly moved in the left and right directions thereof so as to extend the bed and lift the slidingly moved area of the third frame, thereby moving or turning the body of the patient lying on the bed.

5. The articulating bed and the mattress for the articulating bed according to claim 1, wherein the articulating bed is slidingly moved horizontally to the right or left side according to a user's selection and extended by the given width, and the articulating bed is lifted at the slidingly moved area of the third frame such that the body of the patient is turned laterally.

6. The articulating bed and the mattress for the articulating bed according to claim 1, wherein the articulating bed, which is articulated to four sections in forward and backward directions thereof and articulated and lifted to two stages in left and right directions thereof, has the headrest adapted to support the patient's head after the body of the patient is turned in a perpendicular direction to the bed so as to make the patient sit on the bed for the movement of other places.

7. The articulating bed and the mattress for the articulating bed according to claim 1, wherein the mattress assembly has the main mattress located on the center portion thereof and the outside mattresses coupled to the both sides of the main mattress in such a manner as to be slidingly moved freely to a width direction of the articulating bed, thereby allowing the bed width to be extended longer.

8. The articulating bed and the mattress for the articulating bed according to claim 7, wherein the mattress assembly has the main mattress located on the center portion thereof and the outside mattresses coupled to the both sides of the main mattress in such a manner as to be detachably mounted freely to the main mattress by means of the plurality of band-like bridges.

9. The articulating bed and the mattress for the articulating bed according to claim 7, wherein the main mattress and each outside mattress are formed of a cushioning material like a sponge and have an outside cover having an entrance formed thereon in such a manner as to be easily separated therefrom at a time of cleaning or exchanging, the entrance having a slide fastener, snap buttons, or general buttons mounted thereon, and the boundary between the main mattress and each outside mattress is defined by means of sewing, a plurality of strings or bands each having a given width.

10. The articulating bed and the mattress for the articulating bed according to claim 7, wherein each outside mattress is configured to have the same height as the main mattress on the top surface thereof and to have a height higher than the main mattress by a thickness of the third frame on the underside thereof, such that when the third frame is slidingly moved, the main mattress and each outside mattress are at the same height at the top surfaces thereof.

11. The articulating bed and the mattress for the articulating bed according to claim 7, wherein each outside mattress is higher by 2 inches than the main mattress on the underside of the main mattress and higher by 3 inches than the main mattress on the top surface of the main mattress.
